(19) United States
(12) Patent Application Publication
(10) Pub. No.: US 2025/0297369 A1
(43) Pub. Date: Sep. 25, 2025

(54) APPLICATIONS OF A MATTE COATING LAYER IN PRINTING PROCESSES TO CREATE VARYING VISUAL EFFECTS ON PRINTED ARTICLES

(71) Applicant: Kevin Abergel, Melbourne, FL (US)

(72) Inventor: Kevin Abergel, Melbourne, FL (US)

(73) Assignee: Harris & Bruno International, Inc., ROSEVILLE, CA (US)

(21) Appl. No.: 18/614,659

(22) Filed: Mar. 23, 2024

(51) Int. Cl. C23F 4/02; C23F 1/02; C23F 1/44; C25D 5/00; C25D 5/12; C25D 5/16; C25D 5/48

(52) U.S. Cl. CPC C23F 4/02; C23F 1/02; C23F 1/44; C25D 5/12; C25D 5/16; C25D 5/48; C25D 5/627

(57) ABSTRACT

The invention is directed toward applying a matte finish over other under-layers of applied materials upon a substrate to create a finished article with entirely new visual effects. This invention has applications in the printing arts and significant applications to commercial printing. In one embodiment the matte finish transforms glossy digital foil to a visual effect of a matte appearance. In a second embodiment the matte finish imparts a visual effect of an embossed appearance to patterns and designs.

### CROSS-REFERENCE TO RELATED APPLICATIONS

Not Applicable

### BACKGROUND OF THE DISCLOSURE

### Technical Field of the Disclosure

This invention relates to the printing arts and more specifically to the field of using a matte overcoat to cover an underlayer to produce new matte visual effects upon a printed article.

### Description of the Related Art

The use of a matte coating gives a flat visual appearance to articles upon which it is applied. Matte coatings are applied in the field of printing technology to give a matte effect to printed articles such as greeting cards, for example. One method of application of a matte coating is by way of a flood analog coating method that is known in the art. However, up until now, matte finishes have been applied as an end unto themselves, that is, if a printer wanted to give a matte finish to a printed article, then he/she would apply a matte flood analog coating and the article would take on the desired matte appearance. The matte flood analog coating is often applied over colored ink surfaces to give the color a matter appearance. In a comparable way, semi-gloss and gloss finishes are applied to greeting card stock to achieve the ends of a card with a semi-gloss or gloss appearance.

Rather than use a matte finish as an end unto itself, the present invention proposes using a matte finish combined with other underlayers of applied materials on a printing substrate to provide the finished article (such as a greeting card) with entirely new visual effects.

### SUMMARY OF THE DISCLOSURE

The invention described herein is directed toward applying a matte finish over underlayers of applied materials upon a substrate to create a finished printed article with entirely new visual effects. This invention has applications in the printing arts and significant applications to commercial printing.

In a first instance the invention has significant money-saving applications by avoiding the prior art usage of matte foil to create a matte metallic finish. The invention proposes using “digital foil”, a material known in the printing arts which has a glossy metallic appearance, in place of matte foil. At the time of this writing, matte foil is two times (2×) more expensive than digital foil. The invention transforms the glossy metallic appearance of digital foil to a matte appearance. Also, digital foil is easily sourced from printing suppliers whereas matte foil is less available. Applying the invention, the final visual effect of applying a flood matte coating over digital foil is an equivalent matte metallic appearance as matte foil, without the greater expense of matte foil.

In a second instance, the invention proposes first creating pattern designs on a substrate such as greeting card stock, using an inkjet-applied clear UV-curable polymer coating. At the point that the designs are created using the clear polymer coating, they appear glossy, but visually faint to the naked eye. However, it has been found that applying a matte coating over the polymer coating designs has the visual effect of imparting a visually vivid and distinct “relief” to the designs. In this application of the invention, the designs take on an “embossed” appearance. Therefore, this application of the invention is intended to replace traditional roller and pattern-applied embossing to card stock, where applicable. This application of the invention allows the entire embossed appearance to be achieved using printing equipment, thereby excluding the added production steps and expense of running card stock through an embossing machine.

It is an object of the invention to provide different visual effects to printed articles using a matte coating applied over one or more underlayers.

It is a further object of the invention to provide methods and finished articles that employ a matte coating over digital foil to render a matte foil visual effect without the increased expenditure of using matte foil.

It is a further object of the invention to employ a matte coating over raised patterns rendered by an inkjet printer using a clear UV-curable polymer coating to render an embossed appearance without having to employ mechanical embossing equipment.

These and other objectives and advantages of the present invention are described with specificity so as to make the present invention understandable to one of ordinary skill in the art.

### BRIEF DESCRIPTION OF THE DRAWINGS

FIG. 1 is a side cutaway view of a printed article in accordance with the invention which utilizes digital foil as a substitute for matte foil.

FIG. 2 shows a plan view of the face of a greeting card article in accordance with the invention showing progressive stacked cutaway sections to show underlayers including a digital foil underlayer under an analog matte flood coating topcoat which renders a matte appearance to the digital foil.

FIG. 3 is a plan view of a greeting card with a polymer coating underlayer applied in a decorative pattern (here a snowflake design), the polymer coating underlayer being covered under an analog matte flood coating topcoat which gives an embossed appearance to the decorative pattern.

### DETAILED DESCRIPTION OF THE PREFERRED EMBODIMENT

In the following discussion that addresses a number of embodiments and applications of the present invention, reference is made to the accompanying drawings that form a part hereof, and in which is shown by way of illustration specific embodiments in which the invention may be practiced. It is to be understood that other embodiments may be utilized and changes may be made without departing from the scope of the present invention.

As used herein, the singular forms “a”, “an” and “the” include plural referents unless the context clearly dictates otherwise. “And” as used herein is interchangeably used with “or” unless expressly stated otherwise. All embodiments of any aspect of the invention can be used in combination, unless the context clearly dictates otherwise.

Unless the context clearly requires otherwise, throughout the description and the claims, the words ‘comprise’, ‘comprising’, and the like are to be construed in an inclusive sense as opposed to an exclusive or exhaustive sense; that is to say, in the sense of “including, but not limited to”. Words using the singular or plural number also include the plural and singular number, respectively. Additionally, the words “herein,” “wherein”, “whereas” “above,” and “below” and words of similar import, when used in this application, shall refer to this application as a whole and not to any particular portions of the application.

The description of embodiments of the disclosure is not intended to be exhaustive or to limit the disclosure to the precise form disclosed. While the specific embodiments of, and examples for, the disclosure are described herein for illustrative purposes, various equivalent modifications are possible within the scope of the disclosure, as those skilled in the relevant art will recognize.

The invention described herein is directed toward applying a matte finish over other under-layers of applied materials upon a substrate to create a finished article with entirely new visual effects. This invention has applications in the printing arts and significant applications to commercial printing.

In a first instance the invention has significant money-saving applications by avoiding the prior art usage of matte foil to create a matte metallic finish. Matte foil is an expensive component in that matte foil is typically two times (2×) more expensive than digital foil, which has a gloss metallic appearance. Digital foil is also common and can be sourced relatively easily, while matte foil is comparatively less available. As an example, significant cost savings can be achieved in the commercial printing of greeting cards or other finished print articles by applying the invention using digital foil in place of matte foil. The final visual effect applying a flood matte coating over digital foil is an equivalent matte metallic appearance to the prior art use of matte foil, without the significantly greater expense and sourcing problems of matte foil.

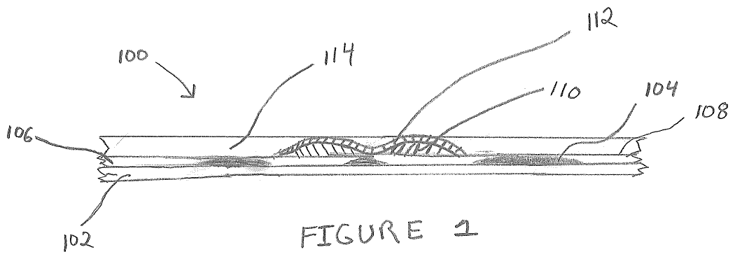

Referring to FIG. 1, a side cutaway view is shown of a greeting card 100 employing the invention. Starting with a substrate 102, such as greeting card stock or other paper substrate, the invention can be applied, but often, the substrate 102 is printed first and the ink 104 must be protected before applying the additional layers that comprise the invention. The printed portion is typically protected using a clear analog flood barrier coat 106 or else a clear laminate layer (not shown) which are methods well known. The barrier coat 106 or laminate layer also give a smooth surface 108 for next applying the polymer coating underlayer 110 comprising the invention.

The added layers comprising the invention giving the visual matte effect to digital foil involve a first underlayer of polymer coating 110 applied directly on the substrate or on the barrier coating/laminate layer previously discussed. The underlayer of polymer coating 110 are clear UV (ultraviolet light) curable fluids that can be applied using inkjet application. An example of such a polymer coating is UV-curable MGI clear varnish. The polymer coating underlayer 110 is preferably inkjet applied in patterns or designs as dictated by the software of the printing machine which controls the inkjet heads. The polymer coating underlayer 110 is then covered by the digital foil underlayer 112, which binds to the polymer underlayer 110 wherever the digital foil underlayer 112 contacts. Digital foils are commonly available from a number of suppliers. The polymer coating underlayer 110 may be inkjet applied in a variety of designs dictated by software. For example, a sympathy greeting card might have a tear drop design applied in polymer coating underlayer or a snowflake on a Christmas card. The digital foil underlayer 112 is laid atop the polymer coating underlayer 110 and adheres to the design. The digital foil contacting the polymer coating design can be stripped away to reveal a metallic tear drop design, snowflake or other applied design. The digital foil adheres to the polymer coating underlayer. For purposes of the invention the digital foil layer is also an underlayer, because it will eventually be flood-coated under a matte coating topcoat layer 114 as further described below.

Next, to give a matte foil appearance to the digital foil underlayer 112, an analog matte layer 114 is flood coated over the underlayers 110, 112, including the digital foil underlayer, thus creating a matte metallic finish. This matte foil visual effect using a digital foil starter material offers significant monetary savings over commercially available matte foil material.

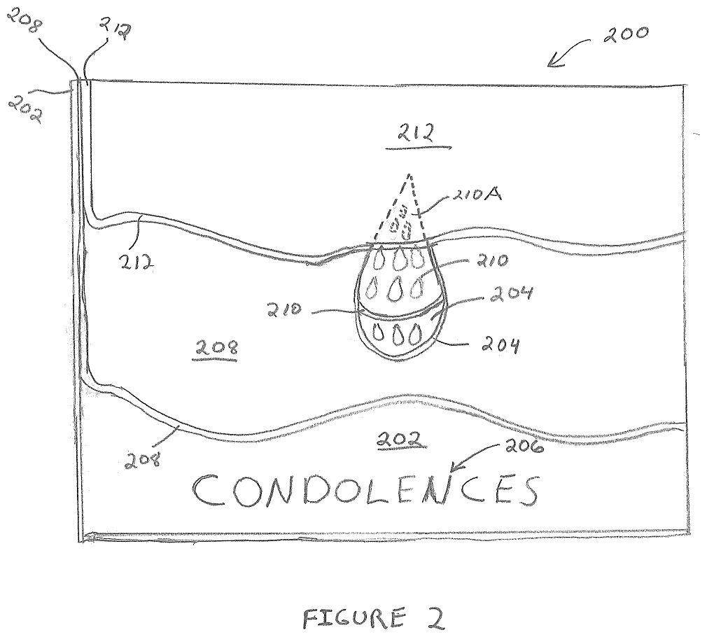

FIG. 2 shows a plan view of the face of a greeting card 200 with progressive stacked cutaway sections showing all the layers applied to give a matte foil visual effect to a digital foil underlayer. Paper card stock layer 202 serves as the substrate upon which the polymer coating underlayer 204 can be directly applied in a desired pattern by an inkjet. However, in most cases, a printed article such as a greeting card 200 has printed wording 206 or bands of color comprising colored ink and these are protected by a clear analog flood barrier coat 208 or else a clear laminate layer. The clear flood barrier coat 208 serves as a smooth surface for the application of additional layers which comprise the invention. The clear polymer coating underlayer 204 (here applied in the shape of a tear drop) is applied directly on top of the barrier coat 208 by inkjet application and the digital foil underlayer 210 is applied on top of the polymer coating underlayer 204 prior to the curing of the polymer coating underlayer 204 such that the pattern is covered by the digital foil underlayer 210. When the polymer coating underlayer 204 has cured, the digital foil underlayer 210 is bonded to the polymer coating underlayer 204. As part of the process, the digital foil underlayer 210 is stripped away and any portion of the digital foil that is not bonded to the polymer coating underlayer 204 is stripped away, leaving the remaining digital foil underlayer 210 bonded to the polymer coating underlayer 204 in the shape of the inkjet-printed pattern of the polymer coating underlayer, here the pattern being a tear drop shaped pattern.

The final top coating is an analog flood coating 212, giving the digital foil underlayer 210 a matte appearance. Here the portion of the digital foil underlayer 210 adopting a matte appearance beneath the analog flood coating 212 is seen in dashed lines and is labeled 210A. The digital foil underlayer 210 is any one of digital foils sourced from printing suppliers. The analog flood coating 212 which creates the matte effect can be sourced from Harris & Bruno, Inc., of Roseville, California. Harris & Bruno's Synergy™ matte analog flood coating is one example that enables the invention. However, in naming this example, there may be other commercially available flood coatings which can give a matte effect to digital foil but are unknown at this writing.

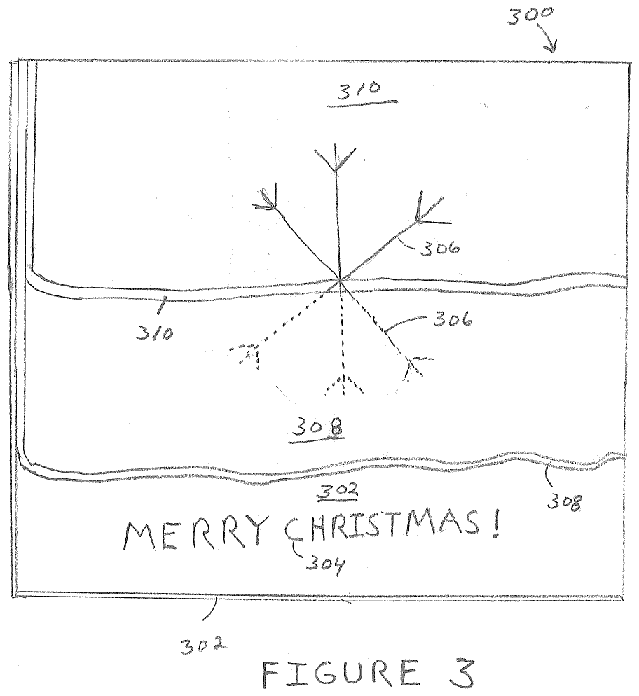

In a second embodiment, represented in FIG. 3, the invention employs an analog matte flood coating over a UV-curable polymer coating underlayer which lies atop a substrate, such as paper cardstock. The cardstock can have a printed layer such as printed lettering or colored areas, the printed layer can be protected by a barrier coating or laminate layer as previously described herein. The inkjet applied polymer coating underlayer is clear and applied in patterns dictated by the software in the inkjet printing machine. When the patterns are cured by UV light, a glossy, slightly raised design remains. An analog flood coating machine which can execute this step of applying the polymer coating underlayer is that supplied by Harris & Bruno, Inc. of Roseville, California, Model ZR30 machine. When an analog flood matte coating topcoat is applied the polymer coating underlayer pattern emerges in greater relief, giving an embossed appearance. The inventive print process just described allows a commercial printer to achieve the appearance of embossed patterns without using embossing rollers and associated embossing machinery. This process can be used on a variety of differently sized articles from greeting cards to posters and signage.

Referring still to FIG. 3, a plan view of the face of a greeting card 300 with progressive stacked cutaway sections showing all the layers applied which comprise the invention. An inkjet-applied UV-curable polymer coating underlayer 306 can be applied directly over the card stock 302 but in most cases, it is applied over ink lettering 304 or coloring on the cardstock 302 that is protected under a clear barrier coat 308 or clear laminate. The polymer coating underlayer 306 is applied in a desired pattern using an inkjet printer, here the pattern is a snowflake. The polymer coating underlayer 306 is glossy and slightly raised in appearance when cured. With application of the analog matte flood coating topcoat 310, the pattern or patterns of the polymer coating underlayer 306 emerge in greater relief, thus giving the visual appearance of embossing. Here the polymer coating underlayer 306 is shown in dashed and solid lines to simulate the sharper embossed appearance (solid lines) when the analog matte flood coating 310 is applied over the polymer coating underlayer 306.

The polymer coating underlayer is cured by UV light application, thus curing the pattern shortly after inkjet application of this layer. The invention is enabled by using the Model ZR30 analog flood coater produced by Harris & Bruno, Inc. of Roseville, California. The preferred polymer coating for the purposes of the invention is UV-curable MGI clear varnish.

The analog matte flood coating top layer is flood-applied over the polymer coating underlayer. The analog flood coating which gives the matte effect can be sourced from Harris & Bruno, Inc., of Roseville, California. Harris & Bruno's Synergy™ analog matte flood coating is one example that enables the invention. The application of the analog matte flood coating causes the patterns of the UV coating underlayer to emerge in greater relief. The relief of the pattern of the polymer coating underlayer emerges in a crisp appearance of the pattern by application of the analog matte flood coating. The quality of the relief is similar to an embossed pattern without necessitating the use of embossing machinery.

Finally, although the description above contains much specificity, this should not be construed as limiting the scope of the invention, but as merely providing illustrations of some of the presently preferred embodiments of the invention. This invention may be altered and rearranged in numerous ways by one skilled in the art without departing from the coverage of any patent claims which are supported by this specification.

I claim:

1. A process for employing digital foil to create a visual effect of matte foil on a printed article, comprising:
a) providing a printing substrate;
b) applying an underlayer of polymer coating over the printing substrate;
c) applying an underlayer of digital foil over the polymer coating underlayer; and
d) applying an analog matte flood coating top layer over the digital foil underlayer, giving the digital foil underlayer the visual appearance of a matte foil.

2. The process for employing digital foil to create a visual effect of matte foil on a printed article as recited in claim 1, wherein the underlayer of polymer coating is applied with an inkjet printer.

3. The process for employing digital foil to create a visual effect of matte foil on a printed article as recited in claim 2, wherein the polymer coating is inkjet-applied in a pattern.

4. The process for employing digital foil to create a visual effect of matte foil on a printed article as recited in claim 3, wherein the digital foil applied to the underlayer of polymer coating is stripped away to adopt the pattern of the underlayer of polymer coating.

5. A process for employing digital foil to create a visual effect of matte foil on a printed article, comprising:
a) providing a printing substrate;
b) applying printing upon the printing substrate;
c) applying a protective layer over the printing;
d) applying an underlayer of polymer coating over the protective layer;
e) applying an underlayer of digital foil over the polymer coating underlayer; and
f) applying an analog matte flood coating top layer over the digital foil underlayer, giving the digital foil underlayer the visual appearance of a matte foil.

6. The process for employing digital foil to create a visual effect of matte foil on a printed article as recited in claim 5, wherein the underlayer of polymer coating is applied with an inkjet printer.

7. The process for employing digital foil to create a visual effect of matte foil on a printed article as recited in claim 6, wherein the polymer coating is inkjet-applied in a pattern.

8. The process for employing digital foil to create a visual effect of matte foil on a printed article as recited in claim 7, wherein the digital foil applied to the underlayer of polymer coating is stripped away to adopt the pattern of the underlayer of polymer coating.
